(19) United States
(12) Patent Application Publication
(10) Pub. No.: US 2018/0334376 A1
(43) Pub. Date: Nov. 22, 2018

(54) MOBILE UNIT FOR DILUTION, STORAGE AND DISPENSING OF CLEANING PRODUCTS

(71) Applicant: PRODIM, Vitrolles (FR)

(72) Inventor: Olivier PETRIGNET, Tavey (FR)

(73) Assignee: PRODIM, Vitrolles (FR)

(21) Appl. No.: 15/972,393

(22) Filed: May 7, 2018

(30) Foreign Application Priority Data
May 22, 2017 (FR) 1754529

(51) Int. Cl. B67D 7/74; B67D 7/02

(52) U.S. Cl. CPC B67D 7/741; B67D 7/344; B67D 7/0294

(57) ABSTRACT

The present invention relates to a mobile cleaning unit for dilution, storage and dispensing of cleaning products (10), that forms a storage-organization cabinet unit (1) mounted on castor wheels (1e) comprising: at least one dilution and dispensing device (2) and a plurality of supply pipes (2-2a, 2-2b, 2-2c) for supplying a plurality of concentrated detergent products stored in a plurality of large reservoirs (8) filled at least in part with various different concentrated detergent products, and a plurality of label dispensers (3) for dispensing labels of various types, and a plurality of compartments (7b) each adapted so as to contain a plurality of the said small container (7) bearing labels of one of the different said cleaning products respectively in the said different compartments.

This application claims priority to French patent application number 1754529, filed May 22, 2017, the contents of which are incorporated herein by reference.

The present invention relates to a mobile and self-contained cleaning unit also referred to hereinafter as a ‘cart’. Since a number of years, cleaning companies have been equipping some of their clients' sites with specific automatic dilution devices for diluting detergents used on those sites. Such dilution devices are marketed in particular by the company EDERMYL (France) and the company SEKO SpA (Italy).

These dilution devices are connected to the drinking water system and equipped with a dip-tube placed into a container or reservoir of concentrated or pure product, which supplies to the personnel responsible for the maintenance of the sites a ready to use aqueous solution. These dilution devices operate by making use of a Venturi system, without a power supply, the drawing of detergent being created by the force of the water supply.

Unfortunately, this type of equipment is installed on less than 5% of the sites, because in the sector of cleaning, a vast majority of sites do not have dedicated facilities/premises for use by the cleaning company, let alone a water supply line for connecting a dilution station thereto.

As a result, across the majority of buildings cleaned in particular all the small sites of the tertiary sector (bank office, insurance agency, postal office, administrative office, public buildings, etc.) the cleaning products made available by the cleaning services providers are:
either delivered as concentrated detergent products in containers of 5 to 25 liters and then diluted more or less approximately with water on site;
or supplied in containers of 1 liter capacity and sprayers in which the detergent product is diluted, and thus directly ready to use.

The shortcomings of these principles are numerous:

For the service personnel:
there exist risks of cutaneous poisoning or eye burns during the dilution operations (projection, tip-over, spilling, forgetting the use of gloves);
handling and manipulation of detergent products therefore present the risk of tipping-over that could lead to same level slip, trip and fall incidents on the slippery floors;
disruptions in supply availability of detergent products may occur and delay the execution of the services or lead to the need to move quickly in order to make a delivery;
the carrying and handling of the containers, by reasons of ergonomics, have an impact on the health of the employee.

For the environment:
the polyethylene containers once empty end up in the waste bins of the clients or in the or dumpsters of the cleaning services agencies;
to enable the proper disposal to waste of these containers, the rinsing thereof becomes necessary and as a consequence thereof a part of the chemical molecules go straight to drain trap of the sink;
the cleaning solutions based on the detergent product are often prepared in an approximated manner, in the absence of other suitable technical solutions, in a bucket by the agents themselves and as a consequence, the solutions could represent a significant impact in terms of environmental pollution upon the agents discharging these solutions in the drains of toilets, following the conclusion of their intervention;
the operational implementation of retention basins not always being possible or being simply forgotten, all incidents impact the environment of these chemical molecules;
from the warehouses of the distributors of cleaning products, shipments of tonnes of detergent products proceed to cover the road network in order to be transported by trucks to the agencies of providers of cleaning services or to the sites of clients and these products not being highly concentrated, these tonnages are made up predominantly of water which, nevertheless, accounts for a significant CO impact on our environment.

More particularly, for the cleaning of industrial establishments, installations or facilities such as workshops, garages, warehouses and factories, commercial or public establishments, facilities or installations of the services sector such as offices, public places, canteens, restaurants or hotels or even sanitary and medical establishments, facilities or installations facilities such as showers, WCs, hospitals, the cleaning personnel uses three types of cleaning products depending upon the type and/or the condition of the surfaces to be cleaned, namely:
neutral degreasing detergent, and
disinfecting detergent, and
descaling detergent.

These products are packaged initially in the form of large containers of 5 to 25 litres of highly concentrated products, but are then delivered to the cleaning companies or directly to the end-user clients preferably in the form of smaller containers diluted products that are ready to use by the cleaning personnel.

These products are in fact used by the cleaning personnel in the form smaller containers of 1 to 2 L at dilutions of 2% to 3% by volume in water prepared from the concentrated products, the said dilutions being different and very precise for the 3 categories of detergents.

Currently, on account of the relatively expensive and toxic nature of the said detergent products, they are delivered to the cleaning companies and to the end-users, in small containers of 1 to 2 L that are pre-diluted and pre-labelled with an indication of the type of detergent, for direct use of the diluted product by the cleaning personnel. Additionally each small container must also include a specific label identifying the product contained and its dosage.

Once a container has been depleted of its content by the cleaning personnel, it is to be rinsed with water before in practice being disposed off by the cleaning personnel once it is emptied—which thus avoids having to manage the recovery of used containers. This therefore results in environmental pollution by way of discharging toxic products during the rinsing process and in addition causes a significant economic loss in terms both of labels as well as containers.

On the other hand, the fact that preparing the dilution requires precise dosing, the delivery of small containers thus represents a relatively large volume of delivery and therefore high transportation costs associated with the use.

Where the goods are delivered in concentrated form and in large containers in order to reduce the transportation costs, this requires for the dilution to be carried out directly by the cleaning companies, and as may be necessary, by the cleaning personnel in small containers from the large concentrated containers. In this case, the risks of product and/or dosing and/or labelling related errors occurring are possible, to say nothing of the risks of environmental damage in case of loss of product during the transferring or decanting of the said toxic products, and also health risks in case of bodily injury in connection with such transferring or decanting of products.

The precision of the dilutions of the cleaning products is a critical prerequisite. In fact, if this type of cleaning product is under-diluted the effects of the cleaning are disastrous, in that the surface being cleaned can get fouled up by the creation of a biofilm, and it must indeed be recognized that, at these ratios of dilution, the visual assessment by the agent at the time of carrying out the dilution is no longer possible.

In addition, in switching from conventional cleaning chemicals diluted at average ratios approaching 3.00% to biotechnology-based cleaning products diluted on average at 0.30%, it is possible to achieve a drop of 8 to 10 times less volumes, fewer trucks on the roads, lower inventories to be held and contained across the establishments and facilities, a real plus in terms of sustainable development.

The objective of the present invention is thus to offer a cleaning device and method that provide the means to improve the economic and ecological conditions related to the preparation, delivery and handling of relatively expensive biotechnology-based cleaning products that require precise and varied specific dilutions by overcoming the disadvantages or problems mentioned here above.

In order to do this, the present invention provides a mobile cleaning unit for dilution, storage and dispensing of cleaning products referred to hereinafter as a ‘cart’, that forms a storage-organization cabinet unit mounted on castor wheels, comprising at least:

a) one vertical rear wall above a horizontal planar work surface disposed between two vertical lateral walls delimiting a front face that is adapted so as to be closed by a detachable shutter member;

b) at least one dilution and dispensing device disposed against the said vertical rear wall or one said lateral wall, above the said horizontal planar work surface;
the said dilution and dispensing device being connected or adapted so as to be connected on to:
   a water supply line, preferably via a first pipe, and
   a plurality of supply pipes for supplying a plurality of concentrated detergent products, extending from the said dilution device to a plurality of large reservoirs filled at least in part with various different concentrated detergent products, and
   a product dispensing pipe for dispensing the detergent cleaning product diluted with water, that extends from the said dilution device for filling the small containers placed on the planar work surface;
the said dilution and dispensing device including a plurality of pre-stored presets of different dilutions corresponding to a plurality of specific dilution concentrations respectively for a plurality of detergent cleaning products diluted based on a given reduced flow rate for filling the said small containers;

c) a plurality of label dispensers for dispensing labels of various types, disposed against the said vertical rear wall or one said lateral wall, above the said horizontal planar work surface; the different types of labels of the various different label dispensers respectively indicating the names of the various different detergent cleaning products; and

d) at least one first retention basin supported or defined by the said horizontal planar work surface, preferably disposed below the said dilution and dispensing device, preferably two retention basins respectively disposed below two dilution stations;

e) a first shelf below the planar work surface supporting a plurality of vertical partitions arranged parallel to the said lateral walls that delimit a plurality of compartments, each adapted so as to contain a plurality of the said small containers bearing labels of one of the different said cleaning products respectively in the said different compartments; and

f) a second shelf or bottom wall supporting a plurality of the said large reservoirs filled at least in part with various different detergent cleaning products, with at least one second retention basin in which are disposed the plurality of the said large reservoirs.

It is understood that:
the two lateral walls are parallel and perpendicular both to the said vertical rear wall and to the said horizontal planar work surface;
the said first retention basin makes it possible to dispose thereon one said small container in order to fill it from the dilution station and to collect and contain possibly a part of the product liquid in the event of eventual leakage during the filling of the small container;
the said detachable shutter member of the front face provides the means to secure access to the products outside of the periods of use or during the moving of the said cart.

This device or cart according to the invention is advantageous in that it makes it possible to:
carry out the dilution of different cleaning products locally, in situ, and to do so in a precise and reliable manner in terms of dosing by making use of the said dilution and dispensing device, and in terms of labelling by making use of the said label dispensing devices;
reduce the number of small containers and labels used on account of the fact that the used containers can be stored in one said compartment after use and can therefore be re-used in addition to reducing environmental damage on account of the fact that the used containers are no longer disposed off and no longer need to be rinsed prior to disposal;
avoid accidental physical or bodily injury or environmental damage occurring during the course of the filling operations or storage of the product by making use of the retention basins;
deliver only large containers of concentrated products to the cleaning companies, or even to the end clients rather than small pre-labelled and pre-diluted containers, which thus represents significant manufacturing and transportation related savings in terms of volume of product transported given the fact that the transferring and decanting of products are carried out locally directly at the mobile cart within the premises of the cleaning company or the client sites during the operational execution;
reduce the environmental impact by reducing the quantities of small empty containers that would go on to fill landfills, on account of the fact that a storage and organization component is provided for the empty containers being returned from the client sites, and due to the fact that deliveries of small containers filled at the sites shall be accompanied by the recovery of small empty containers, which upon return shall either be refilled or placed on standby in the station. Provision has also been made in the storage and organization component for a space for the empty new small containers of 1 litre capacity held in reserve, that may be deployed at new client sites after being labelled on site in accordance with the law, by making use of the label roll holder.

The mobile unit according to the invention is also advantageous in that it makes it possible to reduce:
the occupational hazards in the work activities of the maintenance personnel related to the handling of heavy and dangerous products by limiting the loads, and by providing for optimized ergonomics with respect to operational implementation; and
the risks of error related to handling and preparation of products, due to the preset dilution devices with the cleaning products and containers pre-stored in a differentiated manner and optimized labelling procedures; and
the risks of pollution and accidents related to the products by providing retention basins and reducing the volumes of waste by the recycling thereof (cleaning products and small containers).

This mobile cleaning unit is self-contained thanks to its permanent connection to the water supply source.

More particularly, the mobile unit according to the invention comprises two said dilution and dispensing devices disposed against the said rear wall and the two said first retention basins on the said planar work surface. This embodiment provides the means for simultaneous intervention by two operators. Use is to be made in particular of the Venturi system based dilution and dispensing devices of the company ERDEMYL (France) or SEKO (Italy) known as dispensers that allow for preparing detergent solutions diluted to a precise percentage.

Even more particularly, the said vertical partitions are removable, and movable laterally, the said compartments thus having the ability to be variable in terms of number and volume in order to hold different quantities of the said small containers bearing different labels. Thus, it is possible to provide an initial compartment of large volume containing the unlabeled new empty containers and to subsequently reduce the volume of this compartment in a progressive manner so as to make room for the compartments for labelled containers used in part in order to be reused.

Still more particularly, the mobile cleaning unit according to the invention comprises:
at least one said dilution and dispensing device with at least three settings corresponding to three specific concentrations of dilution of three different detergent cleaning products based on a given reduced flow rate for filling the small containers;
three label dispensers mentioning respectively the names of the said three different detergent cleaning products;
at least three said compartments each containing a different category of containers bearing a said label and at least in part filled with one said different detergent cleaning product in each compartment;
at least three said large reservoirs respectively for each of the three types of detergent cleaning products disposed side by side, the said large reservoirs being equipped with connecting pipes for connecting with a said dilution and dispensing device.

Even more particularly, the said first shelf comprises of four said compartments of which three compartments each contain a different category of containers bearing a said label and at least in part filled with a said different detergent cleaning product in each compartment, a fourth compartment containing empty new containers without labels.

Even more particularly, the said large reservoirs containing the different sais cleaning products are respectively of different colors and the said labels identifying the various different said cleaning products are respectively of different colors.

Even more particularly, the said second shelf or bottom wall supports two rows of a said plurality of the said large reservoirs, preferably two rows of three said large reservoirs of 10 to 25 L capacity. A first row contains the plurality of different large reservoirs containing the various different cleaning products while being connected to the one or more said dilution and dispensing devices. A second row contains the large reserve reservoirs in a manner such that these latter are replaced as soon as they are moved into the first row and/or connected on to a said dilution and dispensing device which makes it possible to avoid the risks of supply disruption or shortage.

Even more particularly, the said dilution and dispensing device includes a single preset for a dosing of one of the said cleaning products but with a higher flow rate. This greater flow rate makes it possible to supply a reservoir for a mobile self-contained cleaning apparatus such as that of an auto-washer and a product dispensing pipe for dispensing the detergent cleaning product diluted with water, that extends from the said dilution device for filling an external receptacle or reservoir such as buckets used by the personnel or a self-contained auto-washer type apparatus.

Even more particularly, each said compartment is adapted so as to receive at least 10 said small containers of 1 to 2 litres capacity, preferably 15 said small containers.

Even more particularly, the said detachable shutter member is constituted by a roller shutter that extends between a ceiling and a floor (bottom) of the said cabinet.

Even more particularly, the said bottom wall or a said lateral wall supports above the planar work surface, a computer such as a tablet equipped with a software program or a support medium with operating instructions, that is adapted so as to assist an operator by displaying instructions that guide the preparation of the said small containers and the actions to be undertaken and/or conduct to be adhered to by the personnel in order to carry out the cleaning.

Even more particularly, the said detergent cleaning products are products that are sourced or derived biotechnologically comprising a plurality of different active ingredients such as stabilizing or surfactant organic compounds, bacterial cultures, enzyme extracts, stabilizers, and inorganic mineral compounds, etc.).

Other characteristic features and advantages of the present invention will become more clearly apparent upon reading the description that will follow, provided by way of illustration and not intended to be limiting, with reference made to the accompanying drawings in which:

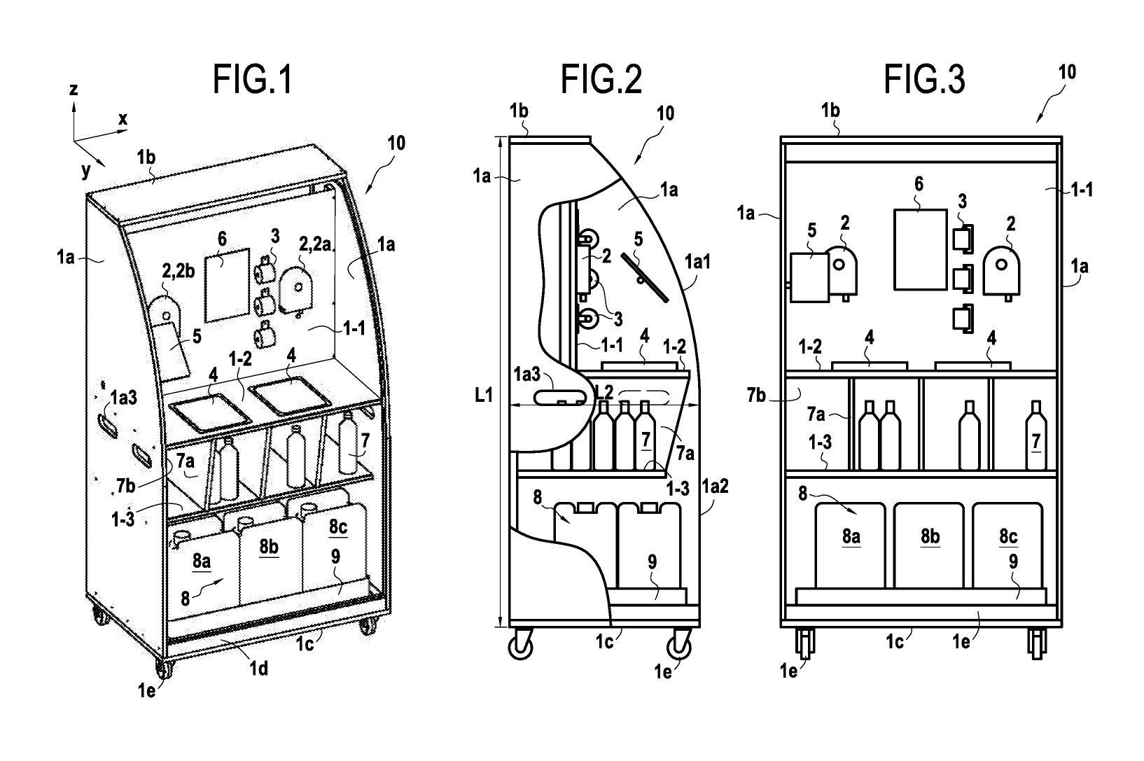

FIG. 1 shows a perspective view of a mobile cleaning unit according to the invention without the connecting pipes;

FIG. 2 shows a view from the side of a mobile cleaning unit according to the invention without the connecting pipes;

FIG. 3 shows a view from the front of a mobile cleaning unit according to the invention without the connecting pipes;

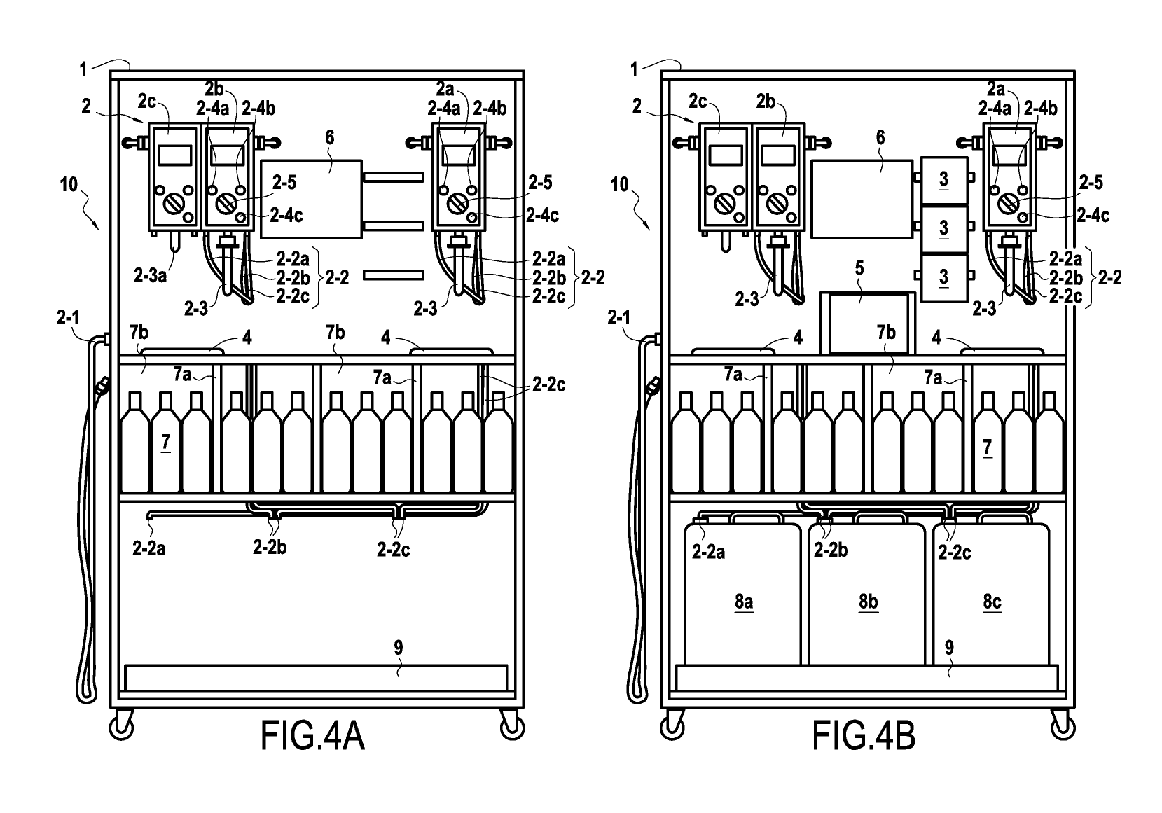

FIG. 4A represents a front view of a mobile cleaning unit according to the invention with small containers 7 and without large reservoirs 8 but with dispensing pipes and connecting pipes 2-2a to 2-2c;

FIG. 4B represent a front view of a mobile cleaning unit according to the invention with small containers 7 and with large reservoirs 8 but with dispensing pipes and connecting pipes 2-2a to 2-2c;

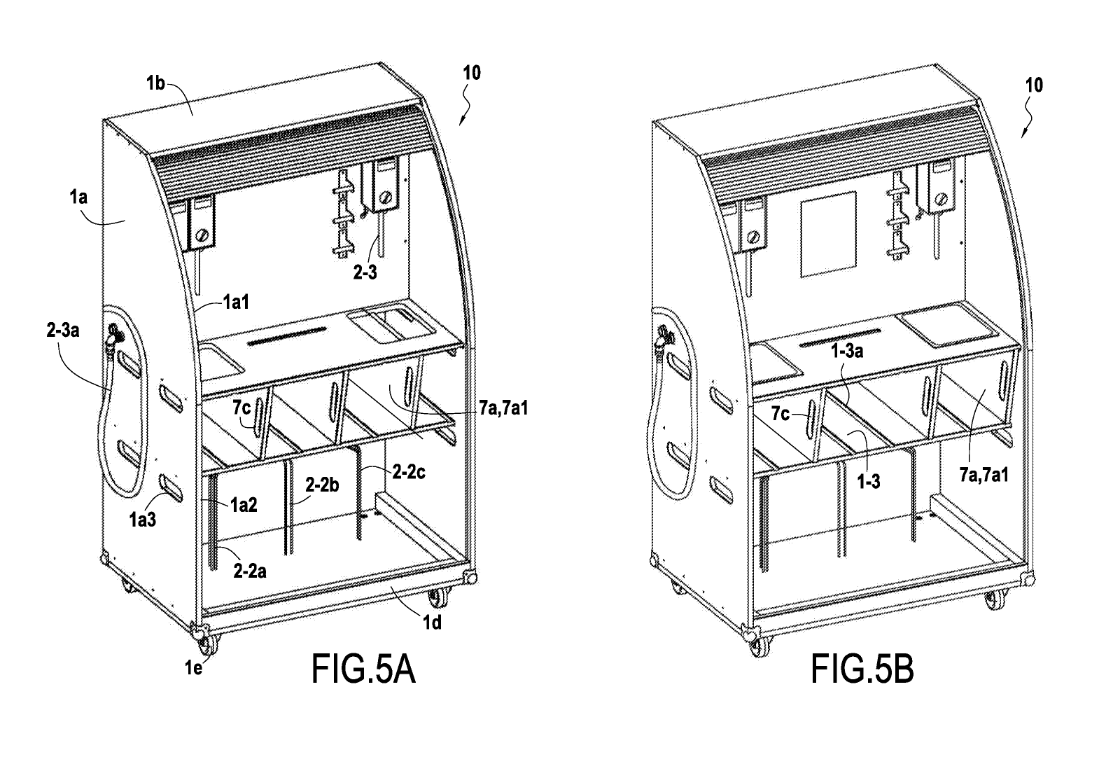

FIG. 5A represents a side perspective view of a mobile cleaning unit according to the invention with movable partitions 7a that are movable in the grooves 7c and one of them 7a1 in a first position;

FIG. 5B represents a side perspective view of a mobile cleaning unit according to the invention with movable partitions 7a that are movable in the grooves 7c and one of them 7a1 in a second position;

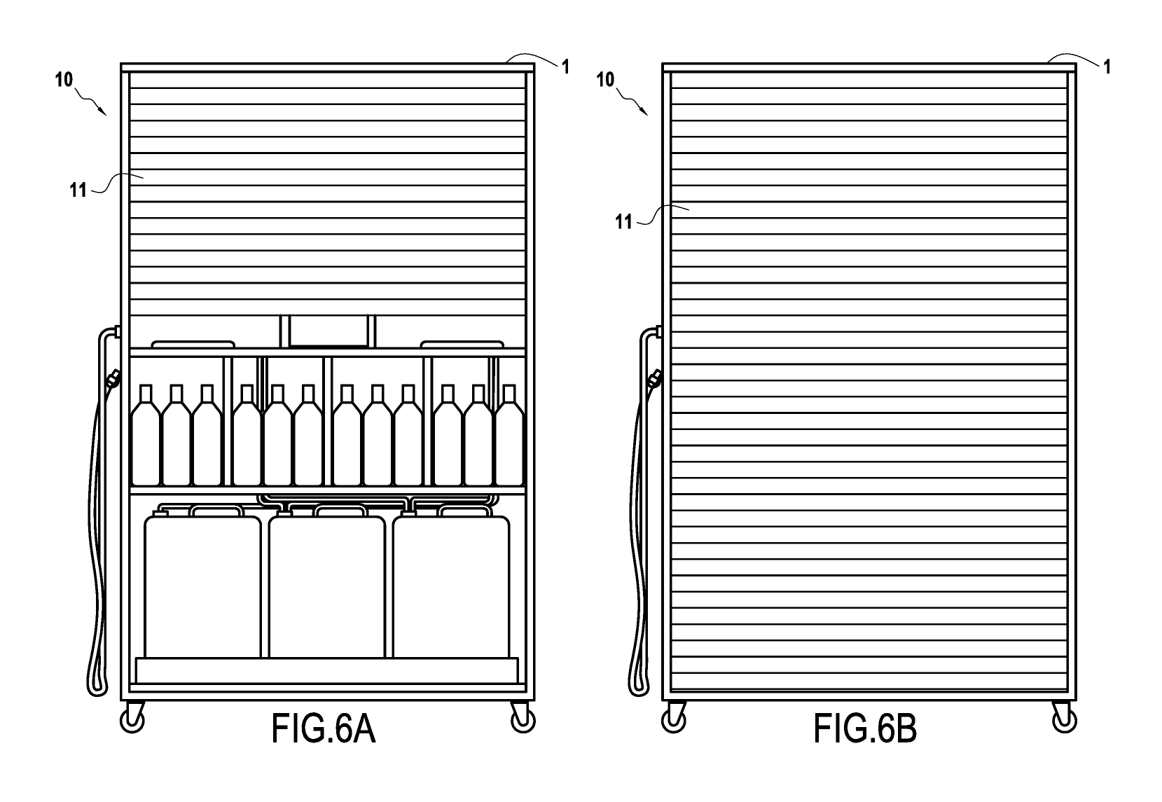

FIG. 6A represents a view of a mobile cleaning unit according to the invention with the shutter partially closed;

FIG. 6B represents a view of a mobile cleaning unit according to the invention with the shutter completely closed;

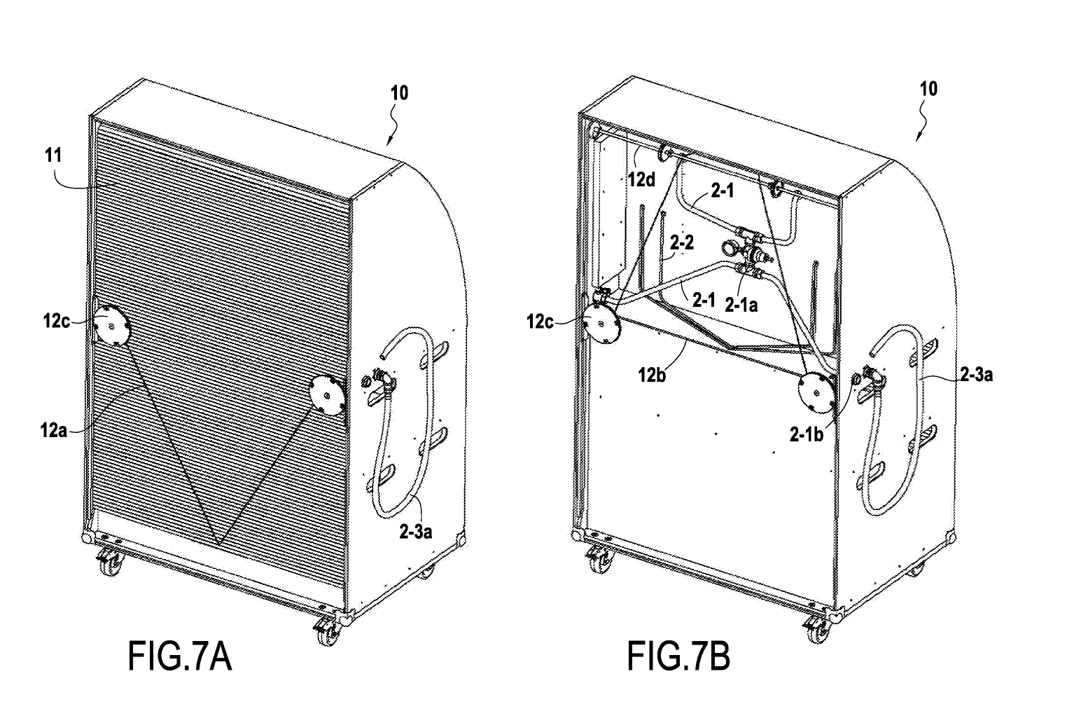

FIG. 7A represents a view of the rear face of a mobile cleaning unit according to the invention when the shutter 11 is open on the front face.

FIG. 7B represents a view of the rear face of a mobile cleaning unit according to the invention without the shutter so as to show the actuating mechanism of the roller shutter.

The mobile cleaning unit 10 or cart according to the invention comprises a storage-organization cabinet unit 1 mounted on four castor wheels 1e that comprises a horizontal ceiling top wall 1b, a vertical rear wall 1-1 above a horizontal planar work surface 1-2 and a horizontal floor wall 1c, disposed between two vertical lateral walls 1a. The depth of the ceiling top wall 1b is less than that of the planar work surface 1-2 and the floor 1c such that the lateral walls 1a have upper front edges 1a1 above the planar work surface which are curved and lower front edges 1a2 below the planar work surface 1-2 which are vertical, the said front edges delimiting a front face adapted so as to be closed by a detachable shutter member 11 in the form of a roller shutter 11. The bottom wall 1c supports on the underside 4 castor wheels with brakes 1e.

The lateral walls 1a include at mid-height and/or in the proximity of the planar work surface level, slots 1a3 that serve as handgrips for manual handling of the cabinet cart.

The planar work surface 1-2 supports two small retention basins 4 intended for receiving small containers 7 during the filling thereof.

The bottom wall 1-1 supports at least 2, preferably 3 dilution and dispensing devices 2, 2a, 2b 2c. These automatic dilution devices are equipped with a Venturi system. The 3 dilution devices 2, 2a, 2b, 2c are supplied with water via a pipe network 2-1 meant to be connected on to a water supply source. The two dilution devices 2a and 2b each include a button 2-5 that provides the ability to select a product inlet by rotation among three product inlets 2-4a, 2-4b, 2-4c corresponding to three supplies of different concentrated cleaning products in three large reservoirs 8a, 8b, 8c via three supply pipes and connecting pipes 2-2a, 2-2b, 2-2c, which extend from the dilution devices up to the three large reservoirs 8a, 8b, 8c. Each of the product inlets/selectors 2-4a, 2-4b, 2-4c may dilute the concentrated products based on a different dilution ratio. Represented in FIG. 7B is a single network of supply pipes 2-1 for supplying water to the dilution devices 2a-2c, which extends behind the rear wall 1-1 with a single valve 2-1a and opens out in 2-1b on the two external faces of the lateral walls 1a as shown in FIG. 7C.

The two dilution devices 2a and 2b each open out on a product dispensing pipe 2-3 for dispensing the detergent cleaning product diluted in water, so as to fill the small containers 7 placed on the planar work surface 1-2 in a retention basin 4. The two dilution devices 2a and 2b provide the means to dispense the products diluted based on two flow rates of 4 l/min and 14 l/min. In practice, one chooses the reduced flow rate of 4 l/min is selected for filling the small containers 7 of 1 L capacity.

A third dilution device 2c is intended to fill a bucket or a larger volume reservoir (not shown) of a self-contained auto washer for cleaning of floors and walls with a diluted product containing the product from one of the 3 large reservoirs 8a, 8b, 8c. In practice, flow rate of 14 l/min is selected for filling this auto washer reservoir.

In addition, disposed on the rear wall 1-1 above the planar work surface 1-2, 3 are the label dispensers 3. The 3 types of labels of the 3 label dispensers respectively mention the names or identification details of the 3 detergent cleaning products of the 3 large reservoirs 8a-8c.

Two small retention basins 4 are arranged on the said horizontal planar work surface 1-2, the two dilution and dispensing devices 2a and 2b.

The 3 large reservoirs 8a, 8b, 8c of 10 to 25 L capacity, filled at least in part with concentrated cleaning products and bearing the relevant labels of one of the different said cleaning products, are disposed in a large retention basin 9 placed on the floor 1c and retained in position by a floor edge 1d. Three other reserve large reservoirs 8a, 8b, 8c have been provided for, and are completely filled with cleaning products in order to avoid supply disruptions or shortages. Thus; the large retention basin 9 contains two rows of three said large reservoirs.

The small containers 7 are stored on a shelf 1-3 disposed below the planar work surface 1-2 and above the large reservoirs 8 placed on the floor 1c. The shelf 1-3 supports 3 vertical partitions 7a disposed parallel to the said lateral walls 1a delimiting four compartments 7b each containing or adapted so as to contain three rows of five containers 7 at least partially filled with the diluted cleaning products bearing the labels of one of the different said cleaning products respectively in three of the said different compartments. A fourth compartment is filled with new empty containers without labels. The compartments 7b having adjustable dividers 7a contain the new and used containers 7 being returned from the sites.

The compartments 7b also serve as storage for the empty containers 7 being returned from the clients sites, because the deliveries of containers 7 filled on the sites are accompanied by the recovery of the empty containers, which upon being returned are either filled again or placed on standby in the station. Provision has also been made in this storage element for a space for empty new containers 7 in reserve, that may be deployed at new clients' sites after having been labelled on site in accordance with the law, by making use of the three label dispenser roller holders.

In FIGS. 5A-5B, the said vertical partitions 7a are movable laterally due to the fact that they are mounted so as to be removable, it being possible for the said compartments 7b to therefore contain different quantities of the said small container bearing different labels. Depending on the site or the type of premises/facilities to be cleaned, it is possible that there may be a lot of containers of one of the products in particular the product “Nu Kleen Smell” described here below which is the current base detergent for the cleaning of all surfaces and few containers of another cleaning product, for example the product “Nu Action 3” described here below because it is only used for descaling of sanitary facilities for example. And thus, there may be a need to store upon their return in the compartments 7b of the unit, more containers of a given product and fewer containers of another product whence the need for this setting.

In order to do this, the removable partitions 7a are set in place or removed by sliding in the parallel grooves 1-3a that are 8 in number, on the upper face of the shelf 1-3. The partitions 7a, 7a1 are provided with a machined slot 1-3a that serves as gripping handle on the front face (similar to those 1a3 serving as handles for the rolling). The moving of the partitions 7a allows the user depending on the configuration necessary, to adjust the number and volume of the compartments 7b.

Thus, it is possible to reduce the number of compartments 7b for example to 3 (FIG. 5B) instead of 4 (FIG. 5A) if one of the three products is not used on a site. The partition 7a that is removed, in order to not be misplaced, may then be handily stored by sliding it into one of the two lateral grooves, created at the interior end of the compartment closely against the lateral walls 1a.

The said large reservoirs containing the different said cleaning products are respectively of different colors and the said labels identifying the various different said cleaning products are respectively of different colors.

On an optional basis, provision is made for a detachable safety shutter constituted by a roller shutter 11 that extends between the ceiling 1b and the floor 1c along the slide rail on the front edges of the lateral walls 1a of the said cabinet unit 1 as represented in FIGS. 6A-6B. This closing shutter curtain 11 provides the means to secure the products and prevent access to any personnel who are not part of the service. This option would be desirable for an equipment unit installed in place at the site of a client benefiting from the cleaning service and where the premises are accessible to the client's personnel or even to their customers. Shown in FIGS. 7A-7B, is the actuating mechanism 12 of the roller shutter 11 that is mounted on an upper shaft 12a and is actuable in opening or closing by respectively winding or unwinding about the shaft 12a making use of a cable 12b wound over spring pulleys 12c.

The said rear wall supports above the planar work surface, a computer such as a tablet 5 equipped with a software program or video to enable watching tutorial videos of the preparation and use of the cleaning products diluted by the users at the dilution station and a support medium with operating instructions 6 or wall chart as a reminder/ready reckoner installed within an integrated support medium, that is able to assist an operator by displaying instructions that guide the preparation of the said small containers and the actions to be undertaken and/or conduct to be adhered to by the personnel in order to carry out the cleaning.

The mobile cleaning unit according to the invention makes it possible to avoid supply disruptions or stock-outs and warehouses being full of products. It also possible to avoid the need for a “cleaning” facility with water supply source and dilution device within the cleaning companies' branches and at the clients' sites.

Two operators can work on the dilution at the same time, 2 stations with 4 product inlets/selectors of which 1 is a high flow rate selector for quickly filling the reservoirs of mobile self-contained cleaning apparatus such as auto-washers. The two dilution devices provide the ability to perform dilutions with 2 operators working simultaneously.

The retention basins 4 and 9 are intended to prevent damage in the event of overflow during the filling or handling of the containers 7 and reservoirs 8 in order to be in compliance with the regulations.

Two rapid connections with flexible hose 2-1 for the drinking water supply inlet are possible from the left or from the right.

Two handles 1a3 in the form of slots on the lateral walls 1a are used to facilitate the moving of the cart on castor wheels.

The pre-dilution is carried out as follows. The dilution devices 2 are configured in order to perform a dilution from the reservoirs 8 of cleaning products described here below concentrated to 20% by volume. On an on-demand basis, a “ready to use” dilution is possible for important sites.

Use is made in particular of the following three products characterized by their highly concentrated biotechnological nature, in particular in the form of kits known by the name “Trio Kleen” from the Company Innuscience (Canada), including for example the following 3 detergents:
the detergent product known by the name “Nu-Action 3”, a degreasing cleaning product containing an ethoxylated C12-C16 alcohol and salts and hydroxides of 1-propanaminium, 3-amino-N (carboxymethyl)-N,N-dimethyl-N-coco acyl at neutral pH for removing stubborn stains, cleaning and degreasing rapidly and deeply all surfaces including floors;
the detergent product known by the name “Nu-Kleen Smell” is a biotechnology-based disinfectant cleaning product for all surfaces that continues to eliminate odors including of urine after the cleaning routine in the waste disposal rooms, merchandise receiving docks, parking areas, stairwells, sanitary facilities, etc. It is also used for general areas (offices, sports centers, etc.) and mirrors, sinks, faucets, basins, countertops, windows.
the detergent product known by the name “Nu-Bio Scrub”, a descaling and decalcifying cleaning product containing an ethoxylated C12-C16 alcohol and lactic acid for cleaning sanitary installations such as showers, bathtubs, urinals, toilets, faucets and fittings and other surfaces exposed to water and/or soap scum and for maintenance of floors in the locker rooms, cloak rooms and around swimming pools as well as for maintenance of surfaces made of stainless steel, brass, copper or other metals.

Listed here above are only the ingredients which have an impact on the risk classification of the product. This is why, for “Nu-Kleen” no ingredients are indicated while for the other two only two ingredients are indicated. But each of these formulations is composed of 10 to 15 different active ingredients (surfactants, bacterial cultures, enzyme extracts, stabilizers, minerals, etc.) and these formulations are all different and specific. The 3 formulations are therefore very different in terms of composition and mode of action.

The use of these biotechnology-based cleaning products, imposes on the concerned operators extremely precise and durable dilutions of these products which present charges that are more than ten times higher as compared to conventional cleaning chemicals. This use, for the reasons cited above, requires the implementation at the clients' sites or at the cleaning company premises, of a diluting station with three multi-purpose concentrated products that allow for precise dilutions and guarantees for product.

When a small container 7 has been depleted of its content by the cleaning personnel, it is no longer necessary to rinse it with water or to throw it away because it is retrieved as on consignment during subsequent deliveries.

The mobile cleaning unit according to the invention thus makes it possible to avoid the disposing of empty containers in the waste on the sites, the rinsing of the empty containers on site and the associated emissions, and there is no longer the need for carrying out local dosing on a constant basis in a dedicated room. The mobile cleaning unit according to the invention further makes it possible to avoid the health risks related to the performing of the dilution on site, and the bearing or handling of heavy reservoirs.

With regard to the dilution performed directly within the janitorial services agencies or the cleaning companies, and as may be necessary by the cleaning personnel in small containers or sprayers from large reservoirs with concentrated products, the risks of product and/or labelling related errors occurring are no longer possible, not to mention the risks of environmental damage in the event of improper decanting or transfer of the said toxic products that are removed, as are the health risks in the event of bodily injury in connection with such transferring or decanting of products.

In practice, use is made of the automatic dilution devices 2a, 2b, marketed by the company SEKO SpA (Italy) under the reference PROMAX under the reference PROMAX 4 product inlets/selectors at flow rate of 4 liters per minute for filling in about 15 seconds the 1 liter capacity containers 7. On these devices, for each of the 4 product inlets/selectors there are four preset positions numbered from 1 to 4, for the selection button 2-5 and positioned upstream, four tips at the base of the device where happen to be connected each of the four dip tubes 2-2a, 2-2b, 2-2c for each of the large products reservoirs 8a, 8b and 8c. Therefore there is one unused position.

The dilution device 2c is a reference device PROMAX 1 product inlet/selector only with one tip connected to a dip tube (not shown) for the product Nu Action 3, which will provide the means to dilute this single product at the rate recommended for mechanized cleaning, at a flow rate of 14 liters per minute in order to rapidly fill (3-4 minutes) buckets or a reservoir of an auto washer, through a pipe 2-3a provided on the external face of a lateral wall 1a on the left side of the casing (FIGS. 4A-4B).

| | Initial | Dilution for | Dilution for |
|---|---|---|---|
| | Concentration | Container 7 | Auto Washer |
| Nu-Kleen | 20% | 0.13 to 0.25% | — |
| Smell | | | |
| Nu Action 3 | 20% | 0.20 0.50% | 0.25% |
| Nu Bio Scrub | 20% | 0.50 2.00% | |

By way of illustration, the following overall dimensions have been studied so as to ensure that the equipment is capable of being placed in all buildings and in particular is able to go through all standard doors and enter elevator cars:
Height H: 1845 mm
Width L1: 1148 mm
Depth L2: 775 mm

The width L1 of 1148 mm has been selected in order to ensure that it can accommodate two persons working simultaneously.

The cart 10 is designed so as to provide for appropriate ergonomics and ease of use to all employees of the cleaning companies who are responsible for the management of the cleaning products. Its lateral faces 1a having rounded front edges allow for the available lighting of the room in which it is positioned to favorably light up the work station, situated at 1.10 m from the ground that is to say, at a height compatible with any person of average height.

What is claimed:

1. A mobile unit for dilution, storage and dispensing of detergent cleaning products, that forms a storage-organization cabinet unit mounted on castor wheels comprising at least:
a) a vertical rear wall above a horizontal planar work surface disposed between two vertical lateral walls delimiting a front face that is adapted so as to be closed by a detachable shutter member;
b) at least one dilution and dispensing device disposed against said vertical rear wall or one said lateral wall above said horizontal planar work surface; said dilution and dispensing device being connected or adapted so as to be connected to:
a water supply line via a first pipe, and
a plurality of supply pipes for supplying a plurality of concentrated detergent products, extending from said dilution device to a plurality of large reservoirs filled at least in part with various different concentrated detergent products, and
a product dispensing pipe for dispensing a detergent cleaning product diluted with water, that extends from said dilution device for filling small containers placed on the planar work surface;
said dilution and dispensing device including a plurality of pre-recorded presets of different dilutions corresponding to a plurality of specific dilution concentrations respectively for a plurality of detergent cleaning products diluted based on a given reduced flow rate for filling said small containers;
c) a plurality of labels dispensers for dispensing labels of various types, disposed against said vertical rear wall or one said lateral wall, above said horizontal planar work surface; different types of labels of various different labels dispensers respectively indicating names of various different detergent cleaning products;
d) at least one first retention basin supported or defined by said horizontal planar work surface disposed below said dilution and dispensing device;
e) a first shelf below the planar work surface supporting a plurality of vertical partitions arranged parallel to said lateral walls, said vertical partitions delimiting a plurality of compartments, each compartment being adapted so as to contain a plurality of said small containers bearing labels of one of the different said detergent cleaning products respectively in said different compartments; and
f) a second shelf or bottom wall supporting a plurality of said large reservoirs filled at least in part with various different detergent cleaning products, with at least one second retention basin in which are disposed the plurality of said large reservoirs.

2. A mobile unit according to claim 1, wherein two said dilution and dispensing devices are disposed against said rear wall and two said first retention basins are disposed on said planar work surface below respectively two said dilution and dispensing devices.

3. A mobile unit according to claim 1, wherein said vertical partitions are removable, and movable laterally, said compartments thus having the ability to be variable in terms of number and volume in order to hold different quantities of said small containers bearing different labels.

4. A mobile unit according to claim 1, characterized in that it comprises:
at least one said dilution and dispensing device with at least three presets corresponding to three specific concentrations of dilution of three different detergent cleaning products based on a given reduced flow rate for filling the small containers;
three labels dispensers mentioning respectively names of said three different detergent cleaning products;
at least three said compartments each containing a different category of containers bearing a said label and at least in part filled with one said different detergent cleaning product in each compartment;
at least three said large reservoirs respectively for each of three types of detergent cleaning products disposed side by side, said large reservoirs being equipped with connecting pipes for connecting with a said dilution and dispensing device.

5. A mobile unit according to claim 1, wherein said first shelf comprises four said compartments of which three compartments each contain a different category of containers bearing a said label and at least in part filled with a said different detergent cleaning product in each compartment, a fourth compartment containing empty new containers without labels.

6. A mobile unit according to claim 1, wherein said large reservoirs containing different said detergent cleaning products are respectively of different colors and said labels identifying various different said detergent cleaning products are respectively of different colors.

7. A mobile unit according to claim 1, wherein said second shelf or bottom wall supports two rows of a said plurality of said large reservoirs of 10 to 25 L capacity.

8. A mobile unit according to claim 1 wherein said dilution and dispensing device includes a single preset for a dosing of one of the said detergent cleaning products but with a higher flow rate, and a product dispensing pipe for dispensing the detergent cleaning product diluted with water, that extends from the said dilution and device for filling an external receptacle or reservoir.

9. A mobile unit according to claim 1, wherein each said compartment is adapted so as to receive at least 10 said small containers of 1 to 2 L capacity.

10. A mobile unit according to claim 1, wherein said detachable shutter member is constituted by a roller shutter that extends between a ceiling and a floor of said cabinet.

11. A mobile unit according to claim 1, wherein said bottom wall or a said lateral wall supports above the planar work surface, a computer such as a tablet equipped with a software program or a support medium with operating instructions, that is adapted so as to assist an operator by displaying instructions that guide the preparation of said small containers and the actions to be undertaken and/or conduct to be adhered to by the personnel in order to carry out a cleaning.
